(19) United States
(12) Patent Application Publication
(10) Pub. No.: US 2004/0239682 A1
(43) Pub. Date: Dec. 2, 2004

(54) Circuit configuration for triggering and a method for adjusting an image display characteristic for a flat screen display

(75) Inventors: Achim Breunig, Seltz (FR); Bernd Homberg, Hagenbach (DE); Uwe Nagel, Karlsruhe (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/801,591

(22) Filed: Mar. 17, 2004

Related U.S. Application Data
(63) Continuation of application No. PCT/DE02/03495, filed on Sep. 17, 2002.

(30) Foreign Application Priority Data
Sep. 17, 2001 (DE) 101 45 770.7

(51) Int. Cl. G09G 5/02

(52) U.S. Cl. 345/602

(57) ABSTRACT

A circuit arrangement for controlling a flat screen display (1) having backlighting and, in particular, for making visible an image that is to be displayed on the flat screen display. The arrangement has a memory (2), in which at least one first table for adapting an image display characteristic (3) in accordance with a first parameter is stored. The arrangement also has at least a second table, which is used to adjust the image display characteristic in accordance with a second parameter. Also, a method for adjusting an image display characteristic of a flat screen display (1) by correcting image data displayed on the flat screen using a table (3), in accordance with the desired adaptation. Several tables are stored in the form of a two-dimensional field and, to adjust the image display characteristic, a table is selected in accordance with two parameters.

This is a Continuation of International Application PCT/DE02/03495, with an international filing date of Sep. 17, 2002, which was published under PCT Article 21(2) in German, and the disclosure of which is incorporated into this application by reference in its entirety.

### BACKGROUND OF THE INVENTION

The present invention relates to a circuit configuration for triggering a flat screen display which has backlighting and, in particular, for displaying an image to be displayed on the flat screen. The invention relates more particularly to such a circuit configuration which has a memory in which at least a first table is stored for adjusting the image display characteristic as a function of a first parameter. In addition, the present invention also relates to a method for adjusting an image display characteristic of a flat screen display, in which the adjustment is performed by correcting the image data on the flat screen display according to the desired adjustment by using a table.

Circuit configurations and methods for displaying an image on a flat screen, in general, are conventionally known. With conventional circuit configurations and/or methods, an image display characteristic of, for example, a color flat screen display is adjusted to the perception of a human eye by correcting the image data displayed on the flat screen display by, in turn, correcting the image data provided for reproduction on the flat screen display. The image display characteristic indicates how an image displaying system reformats an electric image signal into an optical signal. An optical signal is described by three variables: first, by a variable indicating the luminous density, which is responsible for the perception of brightness, and second, by two variables which describe the type of color.

The image display characteristic can be adjusted with the help of a so-called look-up table. There are several quasi standards, such as DICOM or CIELAB, for the image display characteristic. For example, a look-up table may consist of three different tables: one for red, one for green, and one for blue. The form of the image display characteristic can be optimized by way of the look-up table.

A correction may be performed using a graphics processor, which is usually present in a circuit configuration for triggering the flat screen display, to look up which value it should send to the flat screen display, instead of sending the currently prevailing level of the video signal. It is thus possible to alter the image data, which is to be sent to the flat screen display, according to an optimum image display characteristic.

Optimization of an image display characteristic by means of a look-up table is described, for example, in the dissertation by Mr. Achim Breunig, with the title “Development of a Test Stand and Balancing Station for Optimizing the Image Display Characteristic on LCD Display Screens,” which was submitted in October 2000 at the Technical Institute of Karlsruhe, Electrical Engineering Department. This article is incorporated into the present application by reference.

However, one disadvantage of this conventional circuit configuration and/or method is that the image display characteristic can be optimized by the correction data contained in the look-up table only for certain ambient conditions. If the ambient conditions change, the image display characteristic is no longer optimal because it has been corrected according to the previous ambient conditions.

German Patent DE 197 21 984 C2, which is also incorporated into the present application by reference, discloses a monitor having a cathode ray tube, a video amplifier, and a focus and deflecting unit for generating, focusing, and deflecting the electron beam of the cathode ray tube, wherein the monitor still has a video memory and a look-up table circuit configuration connected thereto, said circuit configuration being connected to a digital-analog converter, to which the video amplifier is also connected, and wherein the look-up table that is used is selected as a function of the ambient brightness.

With some conventional monitors, multiple look-up tables are stored in a memory by means of which the image display characteristic is corrected as a function of a certain ambient brightness. In other words, a certain look-up table is selected according to a certain ambient brightness and then used to perform the correction of the image data.

One disadvantage of such conventional monitors is that the image data can be corrected only as a function of the ambient brightness.

### OBJECTS OF THE INVENTION

An object of the present invention is to design a circuit configuration and a method for triggering a flat screen display having a backlighting and for displaying an image to be displayed on the flat screen display, so that the image display characteristic can be optimally adapted to ambient conditions.

### SUMMARY OF THE INVENTION

This object and other objects may be achieved through various illustrative and non-limiting embodiments consistent with the present invention and disclosed in detail below.

The present invention relates to a circuit configuration for triggering a flat screen display, for displaying an image and having a backlighting, comprising: a memory in which at least one first table is stored for adjusting an image display characteristic as a function of a first parameter, wherein at least a further table is provided for adjusting the image display characteristic as a function of a further parameter.

In addition, the present invention also relates to a method of adjusting an image display characteristic of a flat screen display, comprising: storing at least two tables in a memory; selecting one of said tables as a function of two parameters; and

correcting the image data of the flat screen display using the selected table to adjust the image display characteristic.

An optimum image display characteristic can be achieved due to the fact that at least one other table is provided, by means of which the image display characteristic is adjustable as a function of a second parameter. In this manner, other parameters, in addition to the brightness of the ambient light, can thus be taken into account in adjusting the image display characteristic. For example, with a circuit configuration consistent with the present invention, it is also possible, in an advantageous manner, to take the brightness of the backlighting into account in addition to the brightness of the ambient light.

Further, in an advantageous manner, at least three other tables may be provided, and the image display characteristic can be adjusted as a function of two different parameters by using these tables. It is especially favorable if the tables are stored in the form of a two-dimensional field, as is provided in another illustrative and non-limiting embodiment of the present invention. Due to the fact that the tables are stored as a two-dimensional field, for each table containing data for the optimization of the image display characteristic at a certain ambient brightness, it is possible to use additional tables which permit optimization of the image display characteristic that has already been optimized for a certain ambient brightness, e.g., with respect to a different backlighting. The luminous density can be stored as a function of the ambient light and the backlighting, for example, by using the tables which are stored in the form of a two-dimensional field.

Instead of storing the tables as a two-dimensional field, the tables may also be stored as a three-dimensional or multidimensional field. This makes it possible to take other influencing parameters into account.

Instead of storing tables in a memory, it is also possible to use a microcomputer which contains an algorithm for calculating current correction values as a function of the current ambient conditions.

An illustrative and non-limiting embodiment of the present invention that has proven particularly advantageous is one in which there are sensors, by means of which the brightness of the backlighting and the brightness of the ambient light can be detected. This makes it possible, in an advantageous manner, to automatically adjust the image display characteristic to different ambient conditions. For example, if the brightness of the ambient light changes, this change is detected by the respective sensor, so that this change can be used for an automatic selection of a table which contains data for an image display characteristic that has been optimized with respect to the altered ambient light.

It is especially advantageous if there is a control device, by means of which a table for adjusting the image display characteristic can be derived as a function of the output signals of the sensors, as is provided in another illustrative and non-limiting embodiment of the present invention. The control device, preferably, but not necessarily, a microcomputer, makes it possible to adjust the image display characteristic to altered ambient conditions in a fully automatic manner.

A circuit configuration consistent with the present invention achieves the result that the flat screen display always displays images optimally, regardless of ambient conditions. Accordingly, the user need not readjust the settings each time there is a change in ambient conditions. This prevents user errors and yields a consistently high quality of the image display. Moreover, errors in the respective LCD as well as external influences are compensated for in the best way possible.

### BRIEF DESCRIPTION OF THE DRAWINGS

Additional details, features, and advantages of the present invention are derived from the following description of illustrative and non-limiting embodiments with reference to the accompanying drawings:

FIG. 1 shows a block schematic diagram of a circuit configuration consistent with the present invention, and

FIG. 2 shows a schematic diagram of a table configuration stored as a two-dimensional field.

### DETAILED DESCRIPTION OF THE PREFERRED EMBODIMENTS

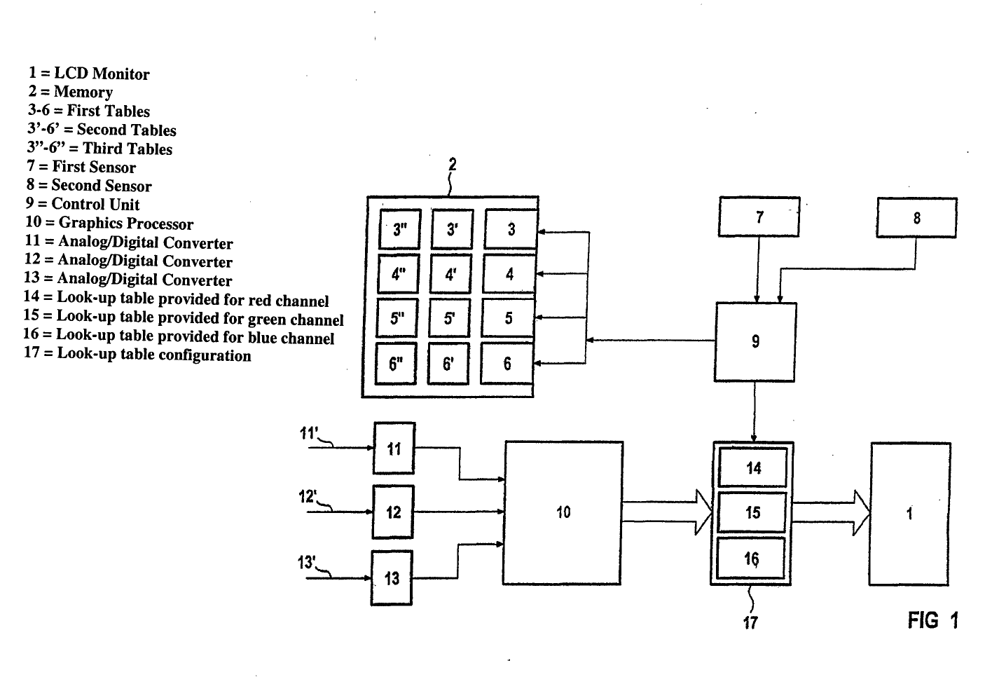

As shown in FIG. 1, an LCD monitor 1 is supplied, via a so-called look-up table configuration 17, with image data, wherein a look-up table 14 is provided for the red channel of the monitor 1, a look-up table 15 is provided for the green channel of the monitor 1, and a look-up table 16 is provided for the blue channel of the monitor 1. The look-up table configuration 17 is, in turn, connected to a graphics processor 10. The graphics processor 10 is responsible for such functions as, for example, scaling, inserting a video image, or inserting an on-screen display (“OSD”). The look-up table configuration 17 (i.e., the look-up tables 14, 15, and 16), receives image data to be displayed by the graphics processor 10 on the monitor 1, and relays this data in corrected form to the monitor 1 according to the data stored in the look-up tables 14, 15, and 16.

The graphics processor 10 receives the image data from analog/digital converters 11, 12, and 13, to which video signals 11′, 12′, and 13′ are applied in analog form. Thus, the video signal 11′ for the red channel in analog form is applied to the digital converter 11. The video signal 12′ for the green channel in analog form is applied to the analog/digital converter 12. The video signal 13′ for the blue channel in analog form is applied to the analog/digital converter 13. The analog signals converted to digital signals then go to the graphics processor 10, where they are processed according to the desired functions. After processing, the digital signals are sent to the look-up table configuration 17, where they are corrected for the optimization of the image display characteristic. The corrected data is then sent to the LCD monitor 1, where it is displayed as an optical image.

The image data coming from the graphics processor 10 is corrected by means of the look-up tables 14, 15, and 16, contained in the look-up table configuration 17, with regard to an optimum image display characteristic under certain ambient conditions. The look-up tables 14, 15, and 16 are written to the look-up table configuration 17 by means of a control unit 9 designed as a microcomputer. For writing the look-up tables 14, 15, and 16 into the look-up table configuration 17, the control unit 9 accesses a memory 2 in which tables 3, 3′, 3″, 4, 4′, 4″, 5, 5′, 5″, 6, 6′, and 6″, to be selected as the selected look-up table, are stored. For the sake of simplicity, in representing the tables, they have not been divided into one table each for the red channel, the green channel, and the blue channel, respectively. However, each table stored in the memory 2 contains data necessary for a look-up table 14 for the red channel, for a look-up table 15 for the green channel, and for a look-up table 16 for the blue channel, respectively.

The data sent by the graphics processor 10 to the look-up table configuration 17 can be adapted by means of the first tables 3, 4, 5, and 6 stored in the memory 2 with regard to an optimum image display characteristic to adjust to differing backlighting with a first ambient light condition.

The data sent by the graphics processor 10 to the look-up table configuration 17 can also be adapted by means of the second tables 3′, 4′, 5′, and 6′ stored in the memory 2 with respect to an optimum image display characteristic to adjust to differing backlighting with a second ambient light condition.

The data sent by the graphics processor 10 to the look-up table configuration 17 can further be adapted by means of the third tables 3″, 4″, 5″, and 6″ stored in the memory 2 with respect to an optimum image display characteristic to adjust to differing backlighting with a third ambient light condition.

For example, if the ambient light is in the second condition, then by means of the control unit 9, the second table 3′, for example, is loaded into the look-up table configuration 17. If the backlighting changes, then the data contained in the look-up table configuration 17 is overwritten with the data of the second table 4′. If the backlighting changes further, then the data contained in the look-up table configuration 17 is overwritten with the data of the second table 5′. However, if the condition of the ambient light changes and the condition of the backlighting remains the same, the data of the second table 3′, for example, is overwritten with the data of the third table 3″ in the look-up table configuration 17.

Depending on the condition of the ambient light and/or the backlighting, one can thus select a certain table from the tables 3, 3′, 3″, 4, 4′, 4″, 5, 5′, 5″, 6, 6′, and 6″, stored in the memory 2 in the form of a two-dimensional field, and this selected table can be written by means of the control unit 9 into the look-up table configuration 17. Thus, the image data supplied by the graphics processor 10 for any condition of the backlighting and ambient light can be corrected with respect to an optimum image display characteristic by means of the look-up table configuration 17.

The circuit configuration shown in FIG. 1 also has a first sensor 7 for detecting the ambient light and a second sensor 8 for detecting the backlighting. The sensors 7 and 8 are connected to the control unit 9. Thus, the control unit 9 can select a corresponding table from the memory 2, depending on the condition of the ambient light and/or the backlighting, and can then write this table into the look-up table configuration 17.

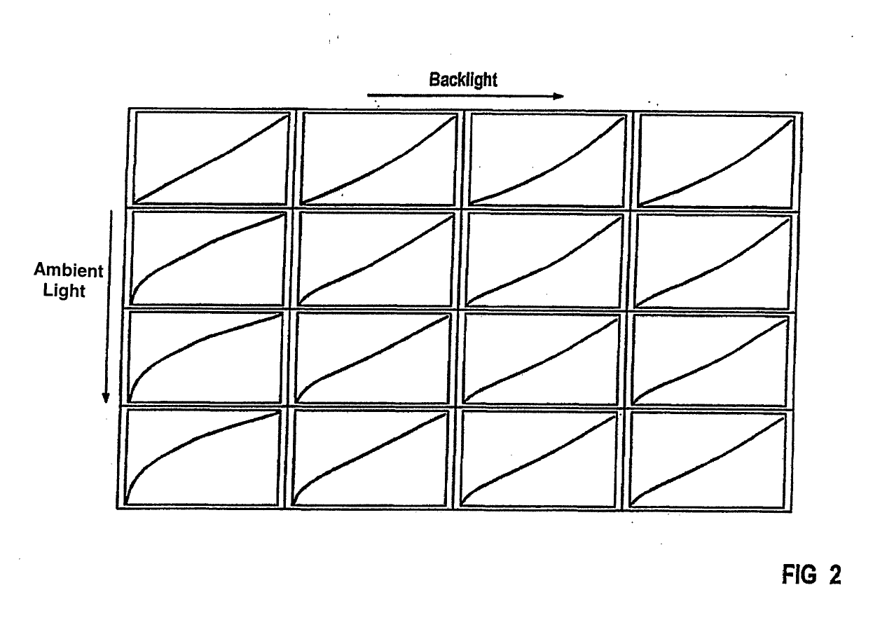

As shown in FIG. 2, the tables arranged in a respective row differ from one another in that they have different transmission characteristics only with respect to the ambient light. The transmission characteristic of the tables arranged in a respective row is constant with regard to the backlighting.

However, the tables arranged in a respective column differ from one another in that they have different transmission characteristics only with respect to the backlighting. The transmission characteristic of the tables arranged in a respective column is constant with regard to the ambient light.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A circuit configuration for triggering a flat screen display, for displaying an image and having a backlighting, comprising:
a memory in which at least one first table is stored for adjusting an image display characteristic as a function of a first parameter,
wherein at least a further table is provided for adjusting the image display characteristic as a function of a further parameter.

2. The circuit configuration as claimed in claim 1, wherein at least a third table and a fourth table are further provided for adjusting the image display characteristic as a function of at least two differing parameters.

3. The circuit configuration as claimed in claim 2, wherein said tables are stored as a two-dimensional field.

4. The circuit configuration as claimed in claim 1, further comprising sensors configured to detect the brightness of the backlighting and the brightness of the ambient light.

5. The circuit configuration as claimed in claim 4, further comprising a control unit configured to select at least one of the tables for adjusting the image display characteristic as a function of the output signals of said sensors.

6. A method of adjusting an image display characteristic of a flat screen display, comprising:
storing at least two tables in a memory;
selecting one of said tables as a function of two parameters; and
correcting the image data of the flat screen display using the selected table to adjust the image display characteristic.

7. A method as claimed in claim 6, wherein said two parameters consist of the ambient light and the backlighting.

8. A method as claimed in claim 6, wherein at least four tables are stored in said memory, and wherein at least one the tables is selected as a function of two parameters to adjust the image display characteristic.

9. A method as claimed in claim 6, wherein the tables are stored as a two-dimensional field.

10. A method as claimed in claim 6, further comprising detecting the brightness of the backlighting and the brightness of the ambient light with sensors.

11. A method as claimed in claim 10, wherein the selection comprises determining a table for adjusting the image display characteristic, as a function of the output of said sensors, with a control unit.
